(19) United States
(12) Patent Application Publication
(10) Pub. No.: US 2013/0062018 A1
(43) Pub. Date: Mar. 14, 2013

(54) LAMINATOR WITH ROLLED PAPER SENSING DEVICE

(71) Applicant: Chun Yu Wu, New Taipei City (TW)

(72) Inventor: Chun Yu Wu, New Taipei City (TW)

(73) Assignees: TEX YEAR INDUSTRIES INC., New Taipei City (TW); TEX YEAR BUSINESS MACHINE(SHEN ZHEN)CO.LTD., Shenzhen (CN)

(21) Appl. No.: 13/448,447

(22) Filed: Apr. 17, 2012

(30) Foreign Application Priority Data
Sep. 14, 2011 (CN) 201120344110.1

(51) Int. Cl. B32B 37/10

(52) U.S. Cl. 156/378

(57) ABSTRACT

This invention discloses a laminator with a rolled paper sensing device, which comprises a machine body, a roller unit; at least one actuating element, sensor and guide. The machine body comprises an inlet, an internal accommodating space and an outlet, which are in communication with one another. Within the accommodating space, the roller unit is located which includes upper and lower rollers, and a channel between the upper and lower rollers leads to the inlet and the outlet; the actuating element is installed and positioned between the roller unit and the outlet; the sensor is located and adjacent to the actuating element; and the guide is located and in communication with the channel and the actuating element. Thus, the aim of sensing rolled paper of the laminator to avoid damaging the laminator and improve the utilization efficiency of the laminator is fulfilled.

### BACKGROUND OF THE PRESENT INVENTION

1. Field of Invention

This invention relates to a laminator, in particular to a laminator with a rolled paper sensing device.

2. Description of Related Arts

Laminators are very common devices available in the market at present. The method of using a laminator is as follows: place an article such as a photo or a certificate behind a laminating film, heat the laminating film and roll the laminating film with rollers to seal the article in the laminating film. Thus, those articles can be well-protected, e.g. damage of the photos and certificates caused by wetting or tearing is avoided.

In other words, when the laminator works, the laminating film which enters the laminator from the inlet is heated by a heating element installed in the laminator and then rolled by the rollers to seal articles such as photos and certificates; after the sealing and encapsulation operations are completed, the articles sealed in the laminating film exit from the outlet of the laminator.

As mentioned above, the lamination operation of the laminator comprises three processes: the laminating film enters the laminator; the laminator heats and rolls the laminating film; and the finished product exits the laminator. However, the laminating film entering the laminator may roll the paper; for example, if the laminating film is adhered to the rollers and rotating along with the rollers, it will be clamped between the rollers to make the paper roll, which may damage the laminator and affect its utilization efficiency. Therefore, this type of laminator is undesirable.

### SUMMARY OF THE PRESENT INVENTION

To overcome the defects of the prior art, this utility model provides a laminator with a roller paper sensing device.

To fulfill the mentioned aim, this utility model adopts the following technical scheme:

A laminator with a rolled paper sensing device comprises a machine body, a roller unit, at least one actuating element, at least one sensor and at least one guide.

The machine body comprises an inlet, an internal accommodating space and an outlet, which are in communication with one another; the roller unit is installed in the internal accommodating space of the machine body and comprises an upper roller and a lower roller which are configured opposite to each other, wherein a channel is located between the upper and lower rollers and leads to the inlet and the outlet; at least one actuating element is installed in the internal accommodating space of the machine body and located between the roller unit and the outlet of the machine body; at least one sensor is located in the internal accommodating space of the machine body and adjacent to at least one actuating element; and at least one guide is located in the internal accommodating space of the machine body and is in communication with the channel and at least one actuating element.

By means of the mentioned structure design, the aim of sensing the rolled paper of the laminator to avoid damaging the laminator and to improve the utilization efficiency of the laminator is fulfilled.

In other words, when lamination is required and after the laminating film enters the laminator, under normal conditions, the laminating film enters the laminator flatly and is heated and rolled; then, the lamination operation is completed. When the paper is rolled, the laminating film will adhere to the upper or lower roller of the roller unit and rotate along with it; then, when touching the guide, the laminating film 10 will be moved to the actuating element by the guide, the actuating element stressed by the laminating film will move to touch the sensor, and the sensor will begin to sense the rolling situation of the paper.

The rolled paper sensing device is generally installed at the upper roller of the roller unit, which means the actuating element, the guide and the sensor are installed at the upper roller. Of course, an actuating element, a guide and a sensor (or just a sensor) can be respectively installed at the upper roller and the lower roller of the roller unit to strengthen the effect of sensing the rolled paper in the laminator.

### BRIEF DESCRIPTION OF THE DRAWINGS

FIG. 1 is a three-dimensional view of a laminator in a preferable embodiment of this invention.

FIG. 2 is a sectional view of a laminator in a preferable embodiment of this invention.

FIG. 3 is a locally magnified lateral view of a laminator in a preferable embodiment of this invention.

FIG. 4 is a locally magnified three-dimensional view of the internal structure of a laminator in a preferable embodiment of this invention.

### DETAILED DESCRIPTION OF THE PREFERRED EMBODIMENT

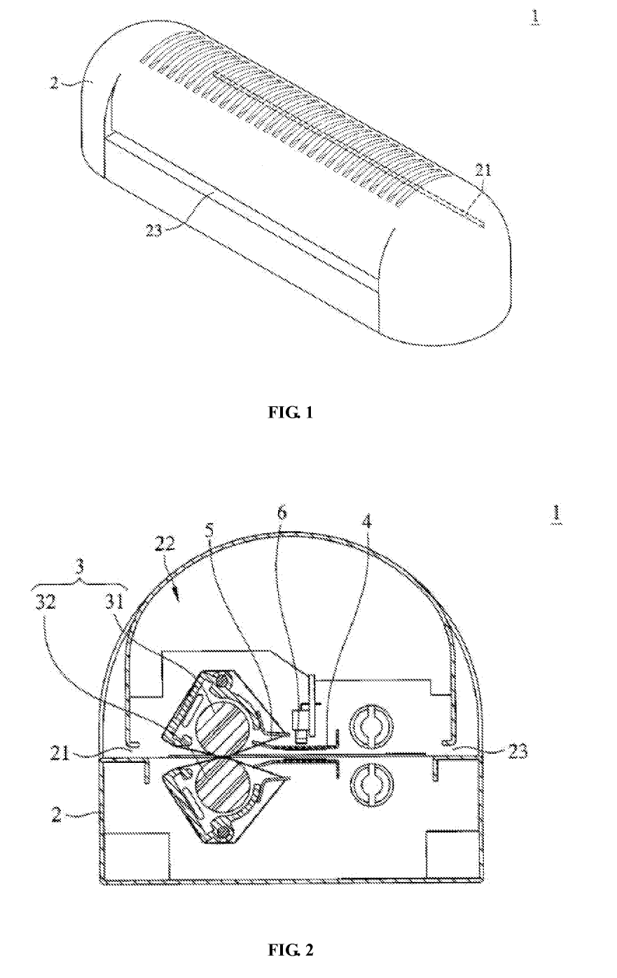

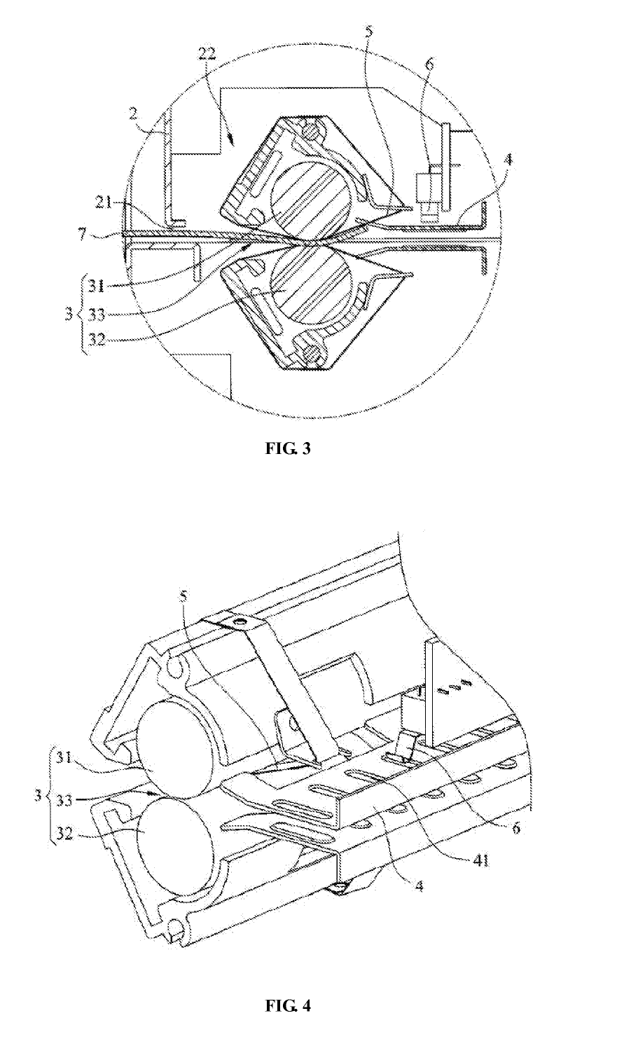

See FIGS. 1-4. FIG. 1 is a three-dimensional view of a laminator in a preferable embodiment of this utility model. FIG. 2 is a sectional view of a laminator in a preferable embodiment of this utility model. FIG. 3 is a locally amplified lateral view of the internal structure of a laminator in a preferable embodiment of this utility model. FIG. 4 is a locally amplified three-dimensional view of the internal structure of a laminator in a preferable embodiment of this utility model.

This invention provides a laminator 1 with a rolled paper sensing device, comprising a machine body 2, a roller unit 3, at least one actuating element 4, at least one sensor 6 and at least one guide 5.

The machine body 2 comprises an inlet 21, an internal accommodating space 22 and an outlet 23, which are in communication with one another; the roller unit 3 is installed in the internal accommodating space 22 of the machine body 2 and comprises an upper roller 31 and a lower roller 32, which are configured opposite to each other, wherein a channel 33 is located between the upper roller 31 and lower roller 32 and leads to the inlet 21 and the outlet 23 of the machine body 2; at least one actuating element 4 is installed in the internal accommodating space 22 of the machine body 2 and located between the roller unit 3 and the outlet 23 of the machine body 2; at least one sensor 6 is located in the internal accommodating space 22 of the machine body 2 and adjacent to at least one actuating element 4; and at least one guide 5 is located in the internal accommodating space 22 of the machine body 2 and is in communication with the channel 33 and at least one actuating element 4.

By means of the mentioned structure design, the aim of sensing the rolled paper of the laminator 1 to avoid damaging the laminator 1 and to improve the utilization efficiency of the laminator 1 is fulfilled.

In other words, in this embodiment, the rolled paper sensing device is installed at the upper roller 31 of the roller unit 3. Thus, when lamination is required and after the laminating film 7 enters the laminator 1, under normal conditions, the laminating film 7 enters the laminator 1 flatly and is heated and rolled; then, the lamination operation is completed.

When the paper is rolled, the laminating film 7 will be adhered to the upper roller 31 of the roller unit 3 and rotate along with the upper roller 31; then, when touching the guide 5, the laminating film 7 will be moved to the actuating element 4 by the guide 5; next, the actuating element 4 stressed by the laminating film 7 will move to touch the sensor 6, and then the sensor 6 will begin to sense the rolling situation of the paper; finally, the laminator 1 will be shut down to avoid damage caused by continuous running with the paper rolled.

In this embodiment, the rolled paper sensing device is installed at the upper roller 31 of the roller unit 3, which means the actuating element 4, the guide 5 and the sensor 6 are installed at the upper roller 31 of the roller unit 3. Of course, an actuating element 4, a guide 5 and a sensor 6 (or just a sensor 6) can be respectively installed at the upper roller 31 and the lower roller 32 of the roller unit 3 to strengthen the effect of sensing the rolled paper in the laminator 1.

In this embodiment, the guide 5 is a heat-resistant (material) guide, and the actuating element 4 is plate-like and has a number of through-holes 41 to ensure a good heat dissipation effect and avoid overheating.

The mentioned embodiment is a just preferable embodiment of this invention. Those skilled in this field shall know that any variation, modification or substitution in the technical concept of this utility model shall be within the protection scope of this utility model. Therefore, the protection scope of this utility model is subject to the claims.

What is claimed is:

1. A laminator with a rolled paper sensing device, comprising:
a machine body, having an inlet, an internal accommodating space and an outlet, which are in communication with one another;
a roller unit, installed in the internal accommodating space and comprising an upper roller and a lower roller which are configured opposite to each other, wherein a channel is located between the upper and lower rollers and leads to the inlet and the outlet;
at least one actuating element, installed in the internal accommodating space and located between the roller unit and outlet;
at least one sensor, located in the internal accommodating space and adjacent to at least one actuating element; and
at least one guide, located in the internal accommodating space and in communication with the channel and at least one actuating element.

2. The laminator with a rolled paper sensing device according to claim 1, characterized in that at least one guide is a heat-resistant guide.

3. The laminator with a rolled paper sensing device according to claim 1, characterized in that at least one actuating element is plate-like and has a large number of through-holes.
